(19) United States
(12) Patent Application Publication
(10) Pub. No.: US 2025/0338234 A1
(43) Pub. Date: Oct. 30, 2025

(54) SYNCHRONIZATION OF USER EQUIPMENT OF DIFFERENT RADIO ACCESS TECHNOLOGIES COEXISTING IN SAME CHANNEL

(71) Applicant: Nokia Technologies Oy, Espoo (FI)

(72) Inventors: Jari Olavi LINDHOLM, Espoo (FI); Vinh Van PHAN, Oulu (FI); Nuno Manuel KIILERICH PRATAS, Aalborg (DK); Daniel MEDINA, Munich (DE); Torsten WILDSCHEK, Gloucester (GB); Faranaz SABOURI-SICHANI, Aalborg (DK); Ling YU, Espoo (FI); Thomas Haaning JACOBSEN, Aalborg (DK)

(21) Appl. No.: 18/858,187

(22) PCT Filed: Mar. 29, 2023
(86) PCT No.: PCT/EP2023/058086

§ 371 Date: Oct. 18, 2024

Related U.S. Application Data
(60) Provisional application No. 63/336,143, filed on Apr. 28, 2022.

(51) Int. Cl. H04W 56/00; H04B 17/318; H04W 92/18

(52) U.S. Cl. CPC H04W 56/0015; H04B 17/318; H04W 92/18

(57) ABSTRACT

Systems, methods, apparatuses, and computer program products for providing synchronization of user equipment of different radio access technologies, such as long term evolution and new radio sidelink, coexisting in the same channel are provided. For example, a first user equipment can receive a first radio transmission from a second user equipment. The first user equipment can determine, based on the received first radio transmission, a misalignment between a first radio transmission timing of the first user equipment and a second radio transmission timing of the second user equipment. The first user equipment can transmit a second radio transmission to a third user equipment indicative of the determined misalignment.

### CROSS REFERENCE TO RELATED APPLICATION

This application claims priority from U.S. provisional patent application No. 63/336,143 on Apr. 28, 2022. The contents of this earlier filed application are hereby incorporated by reference in their entirety.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing synchronization of user equipment of different radio access technologies, such as long term evolution and new radio sidelink, coexisting in the same channel.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory including computer program code. The at least one memory and the computer program code can be configured to, with the at least one processor, cause the apparatus at least to receive, at a first user equipment, a first radio transmission from a second user equipment. The at least one memory and the computer program code can also be configured to, with the at least one processor, cause the apparatus at least to determine, based on the received first radio transmission, a misalignment between a first radio transmission timing of the first user equipment and a second radio transmission timing of the second user equipment. The at least one memory and the computer program code can further be configured to, with the at least one processor, cause the apparatus at least to transmit a second radio transmission to a third user equipment indicative of the determined misalignment.

An embodiment may be directed to a method. The method can include receiving, at a first user equipment, a first radio transmission from a second user equipment. The method can also include determining, based on the received first radio transmission, a misalignment between a first radio transmission timing of the first user equipment and a second radio transmission timing of the second user equipment. The method can further include transmitting a second radio transmission to a third user equipment indicative of the determined misalignment.

An embodiment may be directed to an apparatus. The apparatus can include means for receiving, at a first user equipment, a first radio transmission from a second user equipment. The apparatus can also include means for determining, based on the received first radio transmission, a misalignment between a first radio transmission timing of the first user equipment and a second radio transmission timing of the second user equipment. The apparatus can further include means for transmitting a second radio transmission to a third user equipment indicative of the determined misalignment.

### BRIEF DESCRIPTION OF THE DRAWINGS

For proper understanding of example embodiments, reference should be made to the accompanying drawings, wherein:

FIG. 1A illustrates a frequency division multiplexing coexistence approach;

FIG. 1B illustrates a time division multiplexing coexistence approach;

FIG. 1C illustrates a frequency division multiplexing and time division multiplexing coexistence approach;

FIG. 1D illustrates an approach in which there is overlaid new radio in long term evolution, with dedicated frequency for new radio;

FIG. 1E illustrates an approach in which there is overlaid new radio in long term evolution, without dedicated frequency for new radio;

FIG. 2A illustrates long term evolution sidelink resource allocation mode 3;

FIG. 2B illustrates long term evolution sidelink resource allocation mode 4;

FIG. 3 illustrates long term evolution vehicle to everything subframe slot format for the physical sidelink shared channel and physical sidelink control channel;

FIG. 4 illustrates long term evolution vehicle to everything channelization, with adjacent and non-adjacent physical sidelink control channel and physical sidelink shared channel;

FIG. 5A illustrates a structure of a LTE sidelink synchronization signal/physical sidelink broadcast channel block;

FIG. 5B illustrates a structure of a new radio sidelink synchronization block;

FIG. 6A illustrates a table of various synchronization source priority levels in LTE sidelink for the case of an evolved node B configured as a preferred synchronization source;

FIG. 6B illustrates a table of various synchronization source priority levels in LTE sidelink for the case of a global navigation satellite system configured as a preferred synchronization source;

FIG. 7A illustrates new radio sidelink resource allocation mode 1;

FIG. 7B illustrates new radio sidelink resource allocation mode 2;

FIG. 8A illustrates a sidelink slot format of a slot with physical sidelink control channel/physical sidelink shared channel;

FIG. 8B illustrates a sidelink slot format of a slot with physical sidelink control channel/physical sidelink shared channel and physical sidelink feedback channel.

FIG. 9A illustrates a table of various synchronization source priority levels in NR sidelink for the case of a next generation node B configured as a preferred synchronization source;

FIG. 9B illustrates a table of various synchronization source priority levels in NR sidelink for the case of a global navigation satellite system configured as a preferred synchronization source;

FIG. 10 illustrates a method according to certain embodiments; and

FIG. 11 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing synchronization of user equipment of different radio access technologies, such as long term evolution and new radio sidelink, coexisting in the same channel, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

New radio (NR) sidelink evolution may expand the applicability of NR sidelink to commercial use cases and additionally may consider vehicle to everything (V2X) deployment scenarios in which both long term evolution (LTE) V2X and NR V2X devices may coexist in the same frequency channel. For the two different types of devices to coexist while using a common carrier frequency, a mechanism may be used to efficiently utilize resource allocation by the two technologies without negatively impacting the operation of each technology. Certain embodiments relate to this aspect, namely the coexistence of LTE V2x and NR V2x.

European regulatory administrations have designated the bands 5855-5875 MHz and 5875-5925 MHz-referred to as the 5.9 GHz band—for use by intelligent transport systems (ITS) on the roads. Industry is planning for the deployment of co-existing LTE-V2X and NR-V2X (C-V2X) technologies for direct communications via the PC5 interface in the 5.9 GHz band. Within the 5.9 GHz band, various sub-bands may be designated for non-safety road ITS (5855 MHz to 5875 MHZ), safety-related ITS (5855 MHz to 5915 MHZ), and safety-related rail ITS (5925 MHz to 5935 MHz). The non-safety road ITS sub-band may be shared with non-specific short range devices (SRDs), the safety-related ITS sub-band may partly be prioritized for road ITS (5875 MHz to 5915 MHz) and partly prioritized for rail ITS (5915 MHz to 5925 MHz).

In general, such prioritization may imply that no harmful interference is to be caused to the application having priority. Moreover, road-ITS and rail-ITS may remain confined to their respective prioritized frequency range until such time when appropriate spectrum sharing solutions are defined by ETSI. Vehicle-to-vehicle (V2V) communications for road-ITS may only be permitted at 5915-5925 MHz once spectrum sharing solutions for the protection of rail ITS have been developed at the European Telecommunications Standards Institute (ETSI). In the absence of such sharing solutions for the protection of rail-ITS, national administrations may permit infrastructure-to-vehicle (12V) communications for road-ITS at 5915-5925 MHz subject to coordination with rail-ITS. Furthermore, use of spectrum in the frequency range 5855-5875 MHz may be on a noninterference/non-protected basis, and may include use by non-safety road-ITS and non-specific short range devices.

In the deployment band configuration proposed for C-V2X at 5.9 GHz in Europe, LTE-V2X may be constrained to the 5905-5915 MHz and 5915-5925 MHz sub-bands. The remaining spectrum in the 5.9 GHz band may be available to NR-V2X.

NR SL may employ an in-device coexistence framework including both time division multiplexing (TDM) based and frequency division multiplexing (FDM) based. For operation of TDM-based coexistence, synchronization/subframe boundary alignment may be needed between LTE and NR SL. For long term time-scale TDM operation, LTE SL and NR SL resource pools can be configured not to overlap in the time domain. For short term time-scale TDM operation, for TX/TX and TX/RX overlap, if packet priorities of both LTE and NR sidelink transmissions/receptions are known to both radio access technologies (RATs) prior to time of transmission subject to processing time restriction, then the packet with a higher relative priority may be transmitted/received. Equality priority TX/TX or TX/RX may be up to user equipment (UE) implementation, as may the RX/RX case. Priority of physical sidelink feedback channel (PSFCH) may be the same as the corresponding physical sidelink shared channel (PSSCH). The priorities of LTE physical sidelink broadcast channel (PSBCH) and NR sidelink synchronization signal block (S-SSB) can be configured or pre-configured. If multiple NR SL transmissions/receptions overlap with a single LTE SL TX/RX, the highest priority NR SL TX/RX can determine the priority of the NR SL.

For FDM-based coexistence, there can be a static frequency allocation between NR and LTE SL. Synchronization may not be needed between NR and LTE if frequency separation between LTE and NR is large enough, but in co-channel co-existence operation, frequency separation may not be large enough. Static power allocation may be applied, which may imply that full UE TX power is used only when LTE and NR SL are transmitted simultaneously.

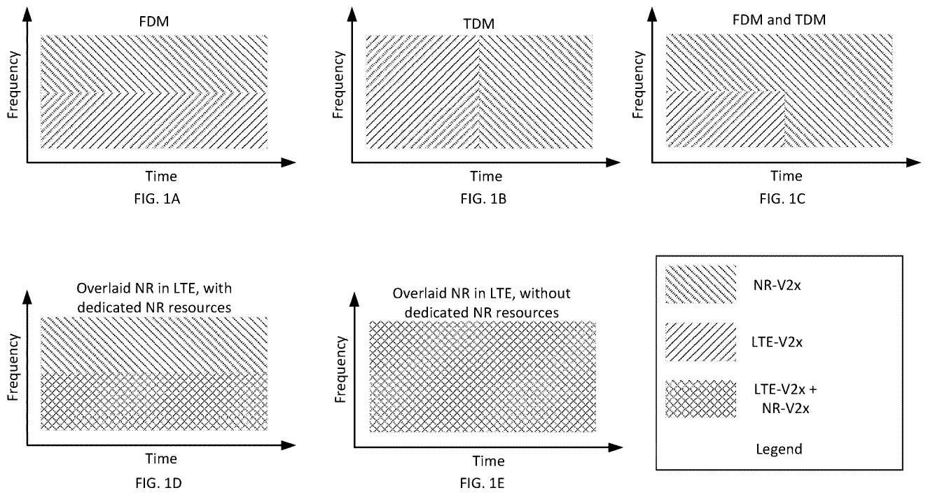

FIGS. 1A through 1E illustrate various time and frequency coexistence approaches. FIG. 1A illustrates an FDM coexistence approach, FIG. 1B illustrates a TDM coexistence approach, and FIG. 1C illustrates a mixed FDM and TDM coexistence approach. FIG. 1D illustrates an approach in which there is overlaid new radio in long term evolution, with dedicated frequency for new radio, while FIG. 1E illustrates an approach in which there is overlaid new radio in long term evolution, without dedicated frequency for new radio. Thus, FIG. 1D illustrates coexistence of LTE-V2X and NR-V2X in the same resources, where NR-V2X has additional dedicated resources. By contrast, FIG. 1E illustrates coexistence of LTE-V2X and NR-V2X in the same resources, where NR-V2X accesses the resources opportunistically.

From a resource use point of view, the examples of dynamic spectrum sharing depicted in FIGS. 1D and 1E may be more flexible and enables higher efficiency than static sharing. However, these schemes may be more complex due to the ancillary mechanisms that enable their coexistence with other systems. In contrast, static spectrum sharing options, as those depicted in FIGS. 1A, 1B, and 1C, may be simpler. FIG. 1E may be the only available option in practice, as the LTE-V2X devices may be configured to occupy the entire bandwidth and NR-V2X devices may need to be able to adapt to that in order to be able to access the ITS band. However, it may be better to allow a NR V2X UE use all the available resources, so that there are no dedicated resources for LTE or NR, but the same resources are available for both, which can be referred to as a complete overlap.

Such complete overlap may not be implemented via enhancement from the LTE-V2X point of view, but instead may be implemented via enhancement from the NR-V2X device point of view. Accordingly, dynamic spectrum sharing schemes may provide approaches for LTE-V2X and NR-V2X coexistence.

Furthermore, as newer vehicles enter the market, it may be beneficial to support advanced V2X use cases that require NR-V2X to operate. Since cooperative awareness messages (CAM) or base safety messages (BSM) can be sent using LTE-V2X and/or NR-V2X, more and more vehicles may utilize NR-V2X and less LTE-V2X. Therefore, by enabling LTE-V2X and NR-V2X to coexist in the same resources, then this may enable a soft re-farming of the LTE-V2X resources. In contrast, if instead static TDM or FDM deployments are considered for LTE-V2X and NR-V2X, this may imply that the resources associated with LTE-V2X will remain allocated potentially for several decades without NR-V2X being able to use those resources. Of course, for this to make sense, NR-V2X may also have to be allowed for safety-related ITS.

In a deployment scenario where NR-V2X devices are able to use the same resources (for example, the case depicted in FIG. 1D, the NR-V2X numerology may need to be contained as perfectly as possible within the LTE-V2X numerology. NR-V2X may be deployed in frequency range 1 (FR1) with a sub-carrier spacing of 30 kHz, while LTE-V2X may have a sub-carrier spacing of 15 kHz. Therefore, in the time-domain, two NR-V2X slots can be contained in one LTE-V2X subframe, while in the frequency domain, an NR-V2X physical resource block (PRB) may have twice the bandwidth of an LTE-V2X PRB. Both LTE-V2X and NR-V2X SL resources may be organized into resource pools, which in the time domain may be organized into slots in NR-V2X or subframes in LTE-V2X. In the frequency domain, these resources may be organized into subchannels composed of a number of PRBs.

The configurable number of PRBs for LTE-V2X and NR-V2X can be as follows: for LTE-V2X, 4, 5, 6, 8, 9, 10, 12, 15, 16, 18, 20, 25, 30, 48, 50, 72, 75, 96, and 100; and for NR-V2X, 10, 12, 15, 20, 25, 50, 75, and 100.

Assuming a perfect overlap between an LTE-V2X resource pool and one (or more) NR-V2X resource pools, the follow pairing of configurations can be provided: for LTE-V2X 20 subchannel configurations, there can be NR-V2X 10 subchannel configurations with perfect overlap; for LTE-V2X 30 subchannel configurations, there can be NR-V2X 15 subchannel configurations with perfect overlap; LTE-V2X 48 subchannel configurations, there can be NR-V2X 12 subchannel configurations with perfect overlap; LTE-V2X 50 subchannel configurations, there can be NR-V2X 25 subchannel configurations with perfect overlap; LTE-V2X 75 subchannel configurations, there can be NR-V2X 25 subchannel configurations with perfect overlap; and for LTE-V2X 20 subchannel configurations, there can be NR-V2X 50 or 25 subchannel configurations with perfect overlap.

This is just an example, but in practice, as there will be multiple LTE-V2X resource pools, it may be possible to achieve any number of LTE-V2X and NR-V2X resource pools. The LTE-V2X and NR-V2X PRBs may be aligned both in time and frequency to enable such various resource pools.

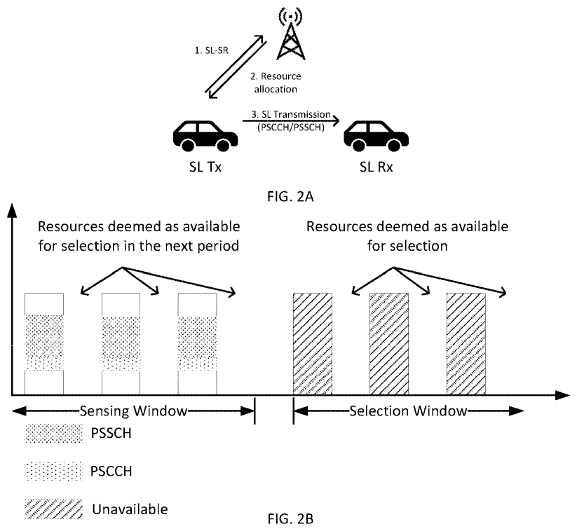

During third generation partnership project (3GPP) release 14 (Rel-14) and release 15 (Rel-15), LTE-V2X has been designed to facilitate vehicles to communicate with other nearby vehicles via direct/SL communication. Communications between these vehicles can take place in LTE-V2X using either mode 3 or mode 4, which are depicted in FIGS. 2A and 2B. More particularly, FIG. 2A illustrates long term evolution sidelink resource allocation mode 3, while FIG. 2B illustrates long term evolution sidelink resource allocation mode 4.

As shown in FIG. 2A, when in mode 3, the sidelink radio resources can be scheduled by the base station or evolved NodeB (eNB). Thus, this approach may be available when vehicles are under cellular coverage. As shown in FIG. 2B, when in mode 4, the vehicles may autonomously select their sidelink radio resources regardless of whether they are under cellular coverage or not. When the vehicles are under cellular coverage, the network can decide how to configure the LTE-V2X channel and can inform the vehicles through the LTE-V2X configurable parameters. The message can include the carrier frequency of the LTE-V2X channel, the LTE-V2X resource pool, synchronization references, the channelization scheme, the number of subchannels per subframe, and the number of RBs per subchannel, among other things. When the vehicles are not under cellular coverage, they can utilize a preconfigured set of parameters to replace the LTE-V2X configurable parameters. The LTE-V2X resource pool can indicate the subframes of a channel that are utilized for LTE-V2X. The rest of the subframes can be utilized by other services, including cellular communications.

The autonomous resource selection in mode 4 may be performed using the sensing and resource exclusion procedure of Release 14, where a vehicle reserves the selected subchannel(s) for a number of periodically recurring packet transmissions. This in turn can be sensed by other vehicles, affecting the resource selection/exclusion decisions of the other vehicles.

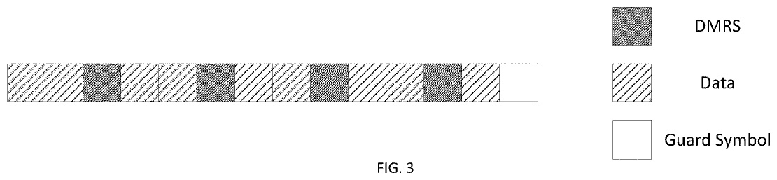

FIG. 3 illustrates long term evolution vehicle to everything subframe slot format for the physical sidelink shared channel and physical sidelink control channel. LTE-V2X can use single-carrier frequency-division multiple access (SC-FDMA) and can support 10 MHz and 20 MHz channels. The channel may be divided into 180 kHz resource blocks (RBs) that correspond to 12 subcarriers of 15 kHz each. In the time domain, the channel can be organized into 1 ms subframes.

Each subframe can have 14 OFDM symbols with normal cyclic prefix. Nine of these symbols can be used to transmit data and four of them, as shown in FIG. 3 the 3rd, 6th, 9th, and 12th, can be used to transmit demodulation reference signals (DMRSs) for channel estimation and combating the Doppler effect at high speeds. The last symbol can be used as a guard symbol for timing adjustments and for allowing vehicles to switch between transmission and reception across subframes. Each of these subframes can be seen in the example illustration of FIG. 3.

The RBs can be grouped into sub-channels. A sub-channel can include RBs only within the same subframe. The number of RBs per sub-channel can vary and can be configured or preconfigured. Sub-channels are used to transmit data and control information. The data can be organized in transport blocks (TBs) that are carried in the physical sidelink shared channel (PSSCH). A TB can contain a full packet, such as a CAM or a BSM. A TB can occupy one or several subchannels depending on the size of the packet, the number of RBs per sub-channel, and the utilized modulation and coding scheme (MCS). TBs can be transmitted using QPSK, 16-QAM or 64QAM modulations and turbo coding.

Each TB can have an associated sidelink control information (SCI) message that can be carried in the physical sidelink control channel (PSCCH). This SCI message can also be referred to as a scheduling assignment (SA). An SCI can occupy 2 RBs and can include information such as an indication of the RBs occupied by the associated TB, the MCS used for the TB, the priority of the message that is being transmitted, an indication of whether the message in the TB is a first transmission or a blind retransmission of the TB, and the resource reservation interval. A blind retransmission can refer to a scheduled retransmission or repetition of the TB, rather than a retransmission based on feedback from the receiver. The resource reservation interval can specify when the vehicle will utilize the reserved sub-channel(s) to transmit the vehicle's next TB. The SCI can include critical information for the correct reception of the TB. A TB may noy be decoded properly if the associated SCI is not received correctly. A TB and the SCI associated with the TB can be transmitted in the same subframe.

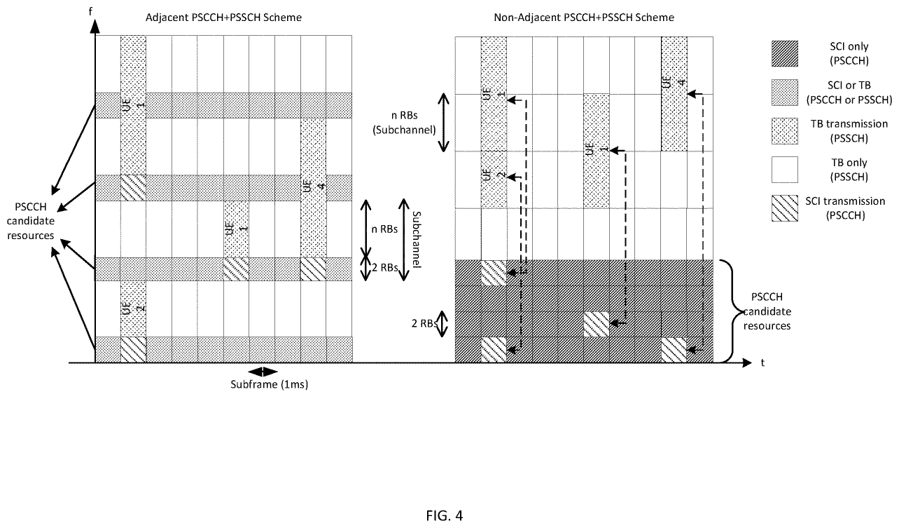

FIG. 4 illustrates LTE-V2X channelization, with adjacent and non-adjacent PSCCH and PSSCH. As depicted in FIG. 4, the TB in PSSCH and the associated SCI in PSCCH can be transmitted in adjacent or non-adjacent sub-channels. For adjacent PSCCH and PSSCH, the SCI and TB can be transmitted in adjacent RBs. For each SCI and TB transmission, the SCI can occupy the first two RBs of the first subchannel utilized for the transmission. The TB can be transmitted in the RBs following the SCI and can occupy several subchannels, depending on the size of the SCI. If the SCI does occupy several subchannels, the SCI can also occupy the first two RBs of the following subchannels.

For nonadjacent PSCCH and PSSCH, the RBs can be divided into pools. One pool can be dedicated to transmitting only SCIs, and the SCIs can occupy two RBs. The second pool can be reserved to transmit only TBs and can be divided into subchannels.

To receive PSCCH, a UE may have to monitor each defined pair of PRBs to determine whether PSCCH has been transmitted in them. Power control procedures for PSSCH and PSCCH are described by way of example in 3GPP technical specification (TS) 36.213, sections 14.1.1.5 and 14.2.1.3, respectively.

For sidelink transmission mode 4, the UE can transmit power P_{PSSCH} for PSSCH transmission in subframe n as follows:

$${P}_{PSSCH} = 10 {log}_{10} ( \frac{{M}_{PSSCH}}{{M}_{PSSCH} + {10}^{\frac{3}{10}} \times {M}_{PSCCH}} ) + A [ dBm ] ,$$

where P_{CMAX} can be defined by 3GPP TS 36.101, M_{PSSCH} is the bandwidth of the PSSCH resource assignment expressed in number of resource blocks, M_{PSCCH}=2, and PL=PL_{c} where PL_{c} can be defined by 3GPP TS 36.213, Clause 5.1.1.1. P_{O_PSSCH,4} and α_{PSSCH,4} can be provided by higher layer parameters p0SL-V2V and alphaSL-V2V, respectively and that can be associated with the corresponding PSSCH resource configuration. If higher layer parameter maxTxpower is configured, then

$$A = min \{ {P}_{CMAX} , {P}_{MAX \_ CBR} , 10 {log}_{10} ( {M}_{PSSCH} + 1 {0}^{\frac{3}{10}} \times {M}_{PSCCH} ) + {P}_{O \_ PSSCH , 4} + {α}_{PSSCH , 4} \cdot PL \} \\ else \\ A = min \{ {P}_{CMAX} , 10 {log}_{10} ( {M}_{PSSCH} + 1 {0}^{\frac{3}{10}} \times {M}_{PSCCH} ) + {P}_{{O}_{-} PSSCH , 4} + {α}_{PSSCH , 4} \cdot PL \} .$$

For sidelink transmission mode 4, the UE can transmit power P_{PSCCH} for PSCCH transmission in subframe n, which can be given by

$${P}_{PSCCH} = 10 {log}_{10} ( \frac{{10}^{\frac{3}{10}} \times {M}_{PSCCH}}{{M}_{PSSCH} + {10}^{\frac{3}{10}} \times {M}_{PSCCH}} ) + B [ dBm ] ,$$

where P_{CMAX} can be defined by 3GPP TS 36.213, M_{PSSCH} can be the bandwidth of the PSSCH resource assignment expressed in number of resource block, M_{PSCCH}=2, and PL=PL_{c} where PL_{c} can be defined by Clause 5.1.1.1. P_{O_PSSCH,4} and α_{PSSCH,4} can be provided by higher layer parameters p0SL-V2V and alphaSL-V2V, respectively and can be associated with the corresponding PSSCH resource configuration. If higher layer parameter maxTxpower is configured then

$$B = min \{ {P}_{CMAX} , {P}_{MAX \_ CBR} , 10 {log}_{10} ( {M}_{PSSCH} + 1 {0}^{\frac{3}{10}} \times {M}_{PSCCH} ) + {P}_{O \_ PSSCH , 4} + {α}_{PSSCH , 4} \cdot PL \} \\ else \\ B = min \{ {P}_{CMAX ,} 10 {log}_{10} ( {M}_{PSSCH} + 1 {0}^{\frac{3}{10}} \times {M}_{PSCCH} ) + {P}_{O \_ PSSCH , 4} + {α}_{PSSCH , 4} \cdot PL \} ,$$

where P_{MAX_CBR} can be set to a maxTxpower value based on the priority level of the PSSCH and the CBR range that includes the CBR measured in subframe n-4.

The difference in power level between PSSCH and PSCCH can then be calculated to be:

$${P}_{PSCCH} - {P}_{PSSCH} = 10 {log}_{10} ( \frac{1 {0}^{\frac{3}{10}} \times {M}_{PSCCH}}{{M}_{PSSCH}} ) = 3 + 10 {log}_{10} ( \frac{{M}_{PSCCH}}{{M}_{PSSCH}} )$$

Thus, the power spectral density (PSD), in terms of the signal's power content versus frequency, of PSCCH can be boosted by 3 dB compared to the PSD of the corresponding PSSCH.

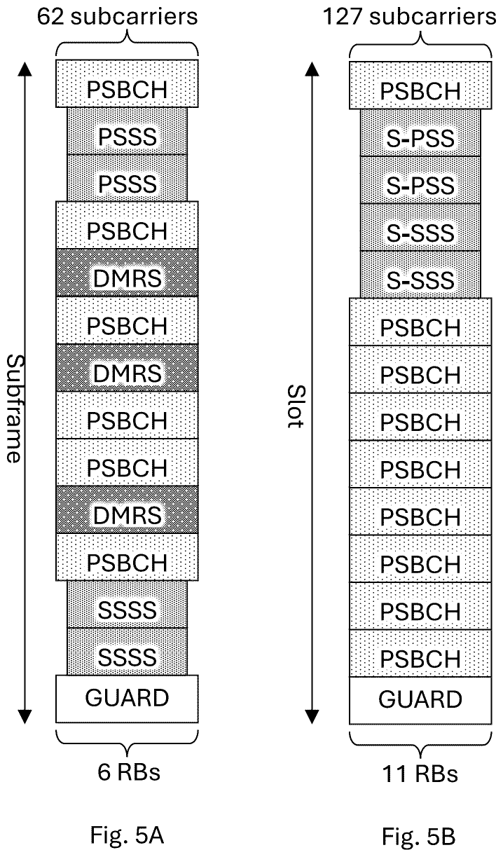

An LTE V2X UE can be synchronized to an evolved node B (eNB), global navigation satellite system (GNSS), or to other V2X UEs by means of sidelink synchronization signals (SLSS). If the highest priority synchronization signal cannot be found, the UE can select a lower priority synchronization source based on predefined priority order. LTE V2X UE forwards the synchronization that it is using to other UEs using SLSS/PSBCH. FIG. 5A illustrates a structure of a sidelink synchronization signal/physical sidelink broadcast channel block.

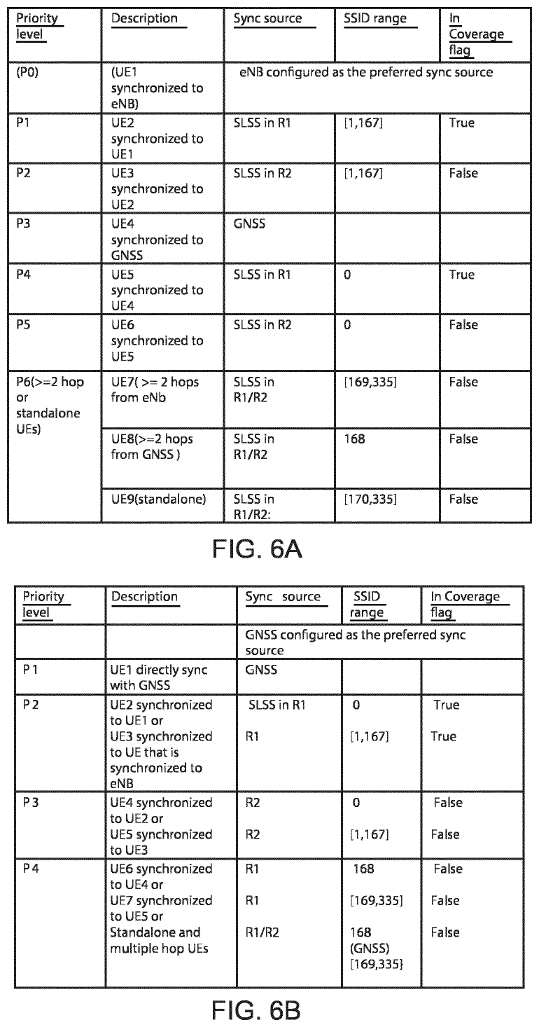

The priority of the synchronization sources in the case when UE does not detect eNB that can be used as the synchronization reference and two resources (R1 and R2) are reserved for SLSS/PSBCH, is presented in the tables of FIGS. 6A and 6B. More particularly, FIG. 6A illustrates a table of various priority levels for the case of an evolved node B configured as a preferred synchronization source, whereas FIG. 6B illustrates a table of various priority levels for the case of a global navigation satellite system configured as a preferred synchronization source. The SLSS identities can be transmitted with primary sidelink synchronization signal (PSSS)/secondary sidelink synchronization signal (SSSS) and in-coverage information can be transmitted in PSBCH. PSBCH can also include information on channel bandwidth, time division duplex (TDD) configuration and direct frame number (DFN) in the channel.

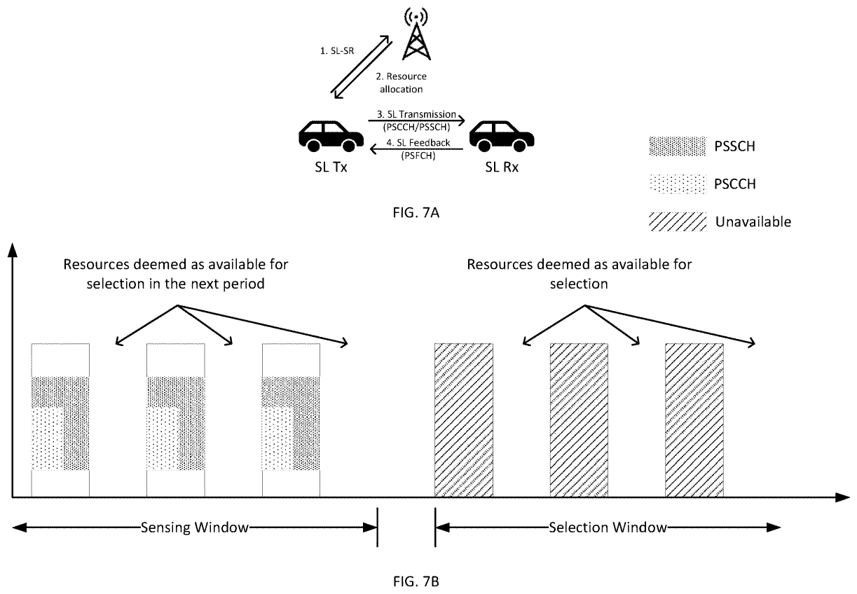

FIG. 7A illustrates new radio sidelink resource allocation mode 1, while FIG. 7B illustrates new radio sidelink resource allocation mode 2. During 3GPP release 16 (Rel-16), NR SL has been designed to facilitate UE communication with other nearby UE(s) via direct/SL communication. Two resource allocation modes have been specified, and a SL transmitter (TX) UE can be configured with one of the modes to perform its NR SL transmissions. These modes are denoted as NR SL mode 1, illustrated in FIG. 7A, and NR SL mode 2, illustrated in FIG. 7B. In mode 1, a sidelink transmission resource can be assigned or scheduled by the network (NW) to the SL TX UE, while a SL TX UE in mode 2 can autonomously select the SL TX US's own SL transmission resources.

In mode 1, where the next generation Node B (gNB) may be responsible for the SL resource allocation, the configuration and operation may be similar to the one over the Uu interface, as shown in FIG. 7A. The medium access control (MAC) level details of this procedure are given by way of example in section 5.8.3 of 3GPP TS 38.321.

In mode 2, the SL UEs can autonomously select resource(s) with the aid of a sensing procedure. More specifically, a SL TX UE in NR SL mode 2 can first perform a sensing procedure over the configured SL transmission resource pool(s), in order to obtain the knowledge of the reserved resource(s) by other nearby SL TX UE(s). Based on the knowledge obtained from sensing, the SL TX UE may select resource(s) from the available SL resources. In order for a SL UE to perform sensing and obtain the necessary information to receive a SL transmission, the SL UE may need to decode the SCI. In release 16, the SCI associated with a data transmission includes a 1st-stage SCI and 2nd-stage SCI, and their contents are standardized in 3GPP TS 38.212, for example.

The SCI can follow a 2-stage SCI structure, for example to support the size difference between the SCIs for various NR-V2X SL service types, such as broadcast, groupcast, and unicast. The 1st-stage SCI, SCI format 1-A, can be carried by PSCCH and can contain information to enable sensing operations and/or information for determining resource allocation of the PSSCH and for decoding 2nd-stage SCI. The 2nd-stage SCI, SCI format 2-A and 2-B, carried by PSSCH, multiplexed with SL-SCH, may include the following: source and destination identities, information to identify and decode the associated SL-SCH TB, control of hybrid automatic repeat request (HARQ) feedback in unicast/groupcast, and/or trigger for channel state information (CSI) feedback in unicast.

The configuration of the resources in the sidelink resource pool can define the minimum information required for a RX UE to be able to decode a transmission. The minimum information may include the number of sub-channels, the number of PRBs per sub-channels, the number of symbols in the PSCCH, which slots have a PSFCH and other configuration aspects, which are omitted for simplicity here.

The details of the actual sidelink transmission, the payload, can be provided in the PSCCH, as 1st-stage SCI, for each individual transmission. The details of the payload can include: the time and frequency resources, the demodulation reference signal (DMRS) configuration of the PSSCH, the modulation and coding scheme (MCS), and PSFCH, among others.

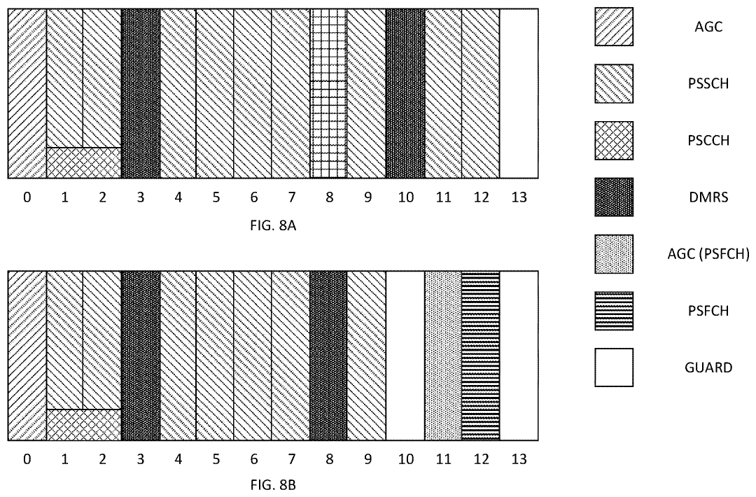

An example of the SL slot structure is depicted in FIGS. 8A and 8B, which show a slot with PSCCH/PSSCH and a slot with PSCCH/PSSCH where the last symbols are used for PSFCH. More specifically, FIG. 8A illustrates a sidelink slot format of a slot with physical sidelink control channel/physical sidelink shared channel, whereas FIG. 8B illustrates a sidelink slot format of a slot with physical sidelink control channel/physical sidelink shared channel and physical sidelink feedback channel.

The configuration of the PSCCH, for example DMRS, MCS, and number of symbols used, can be part of the resource pool configuration. Furthermore, the indication of which slots have PSFCH symbols can also be part of the resource pool configuration.

However, the configuration of the PSSCH, for example the number of symbols used, the DMRS pattern and the MCS, can be provided by the 1st-stage SCI which can be the payload sent within the PSCCH and which can follow the configuration depicted in Table 8.4.1.1.2-1 of 3GPP TS 38.211. The second SL symbol, which can contain the first PSCCH or PSCCH/PSSCH symbol, can be duplicated in the first SL symbol that is used for automatic gain control (AGC) purposes.

More specifically, see Table 8.4.1.1.2-1 of 3GPP TS 38.211 for PSSCH DMRS configurations based on the number of used symbols and duration of the PSCCH. In NR V2X, a TX UE can transmit PSSCH and PSCCH with the same power spectral density, for example with the same power over a PRB, in all symbols with PSCCH, PSSCH or PSCCH/PSSCH.

NR sidelink synchronization block can include primary and secondary synchronization signals and a broadcast channel as in LTE. FIG. 5B illustrates a structure of a new radio sidelink synchronization block. Compared to LTE, DMRS of PSBCH is transmitted in in the PSBCH symbols in some of the resource elements.

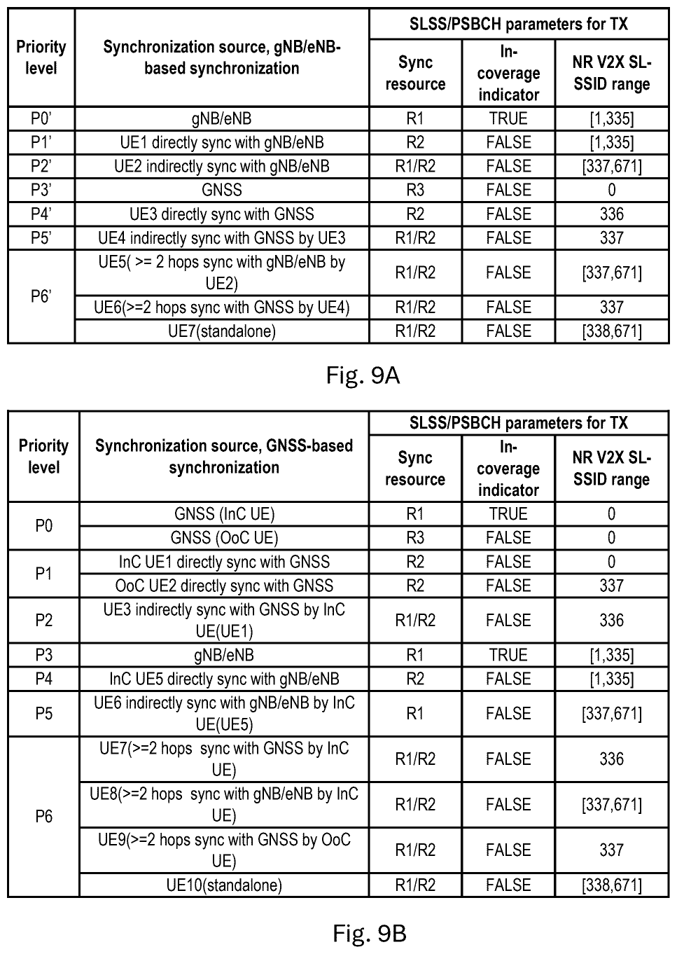

The number of SLSS-IDs transmitted in S-PSS/S-SSS can be increased from 336 in LTE to 672 in NR. The starting point for defined priorities of synchronization sources was LTE so the tables shown in FIGS. 9A and 9B are similar to LTE prioritization. More specifically, FIG. 9A illustrates a table of various priority levels for the case of a gNB or eNB configured as a preferred synchronization source, whereas FIG. 9B illustrates a table of various priority levels for the case of a global navigation satellite system configured as a preferred synchronization source.

In order to support V2X deployment scenario where both LTE-V2x and NR-V2x devices coexist in the same frequency channel, slot and subframe boundaries of the LTE and NR devices may benefit from alignment. The first symbols of the NR SL slot and LTE SL subframe can be used to set the AGC level of the receiving UE. If the transmission of the LTE SL UE starts after the NR SL UE has set its own AGC, the reception of the remaining NR symbols may fail because LTE SL transmission can overload the NR SL UE receiver. The opposite is also true: NR SL UE transmission may overload LTE SL receiver if NR transmission starts after the AGC setting of LTE SL UE.

In the V2x carrier/frequency channel that is intended to be used by both LTE and NR SL devices, the UEs may be configured to prioritize the same synchronization source and the highest priority synchronization source may be GNSS, global positioning satellite (GPS), or the like. For ease of reference any such satellite reference source is illustrated by GNSS. GNSS cannot be received everywhere, for example in tunnels and underground parking lots. In such GNSS out of coverage areas, the UEs may need to switch to lower priority synchronization source(s), which can be a base station or another SL UE that is transmitting synchronization signals.

According to the current specifications, LTE SL UE can synchronize to eNB and SLSS from another LTE SL UEs and GNSS, but the LTE SL UE cannot synchronize to gNB or SLSS from NR SL UEs. On the other hand, besides GNSS, NR SL UE can synchronize to eNB or gNB, if the radio access node has a corresponding Uu interface module, and to SLSS from another NR SL UE. The NR SL UE in those specifications cannot synchronize to SLSS from LTE SL UEs. As a result, there is high probability that the NR and LTE SL UEs cannot find common synchronization source if the connection to the main synchronization source is lost.

Certain embodiments address synchronizing the NR and LTE subframe boundaries when there is no common synchronization source for NR and LTE SL devices present.

As can be seen from the synchronization prioritization tables of FIGS. 6A, 6B, 9A, and 9B, the common synchronization sources for LTE and NR V2X UEs can include GNSS and eNB. The UE behavior that is currently defined in specifications may suffice if all the UEs in the channel are synchronized to those references directly or indirectly via another SL UE.

A NR UE may detect if the transmission in the SL channel is from LTE SL UE based of frequency domain characteristics of the received signal. In certain embodiments the ability to detect LTE transmission can be utilized and developed.

LTE SL UEs may already be deployed in the frequency channel that is intended for coexistence operation and the behavior of such UEs may be viewed as unchangeable from the point of view of a user equipment of interest, which may be implementing certain embodiments. For example, the NR SL UEs may be configured to detect and adapt to the LTE SL subframe boundaries. Certain embodiments may be implemented in NR SL UEs that are deployed in the same V2X carrier/frequency channel where LTE SL UEs already exist.

In certain embodiments, an NR SL UE may be able to detect subframe boundaries of LTE SL transmissions and potentially also DEN used by LTE. This may be based on the following. An NR SL UE may have LTE SLSS reception capabilities, and potentially also capability to decode LTE PSBCH, so that the NR SL UE can synchronize to LTE SL transmission.

Additionally, an NR SL UE may not have LTE SLSS reception capabilities, but the NR SL UE may recognize LTE SL transmissions based on the time and frequency characteristics of the LTE SL transmissions. In LTE V2x, PSCCH corresponding to 24 subcarriers of 15 kHz SCS may be transmitted with 3 dB higher PSD than the PSSCH in the same subframe, as explained above. When NR SL UE finds transmissions with these frequency characteristics, the NR SL UE may find the starting and ending points of the LTE SL transmission and conclude the subframe boundaries of LTE SL transmissions. The last symbol of the LTE V2X transmission may be reserved for guard period, and nothing may be transmitted then, as explained above. The guard period may make it easier to detect starting and ending points even if multiple consecutive subframes are used for transmission.

After the detection of LTE SL timing synchronization, a NR SL UE can forward the timing synchronization information of LTE SL UEs to other NR SL UEs in the carrier/frequency channel. If the NR UE finds that the difference in synchronization between LTE and NR SL UEs is smaller than some predefined value, such as a cyclic prefix length, then the NR SL UE may omit the forwarding of timing synchronization. NR S-SSB/PSBCH can be used for forwarding the timing synchronization especially if priority of LTE timing can be detected to be higher than or the same as the current NR timing.

If priority of LTE timing is lower than the current NR timing, a message indicating offset between timing of NR and LTE may be used and the NR UE may keep on using the NR UE's current timing.

NR SL UEs, receiving the NR S-SSB/PSBCH that indicates timing synchronization used by LTE devices, can switch to use that synchronization source based on predefined priorities of the synchronization sources in the carrier/frequency channel. Alternatively, if the timing offset message is received, the NR UE may be able to deduce which NR SL transmissions or resource pools would collide with LTE.

In addition, there can be NR SL UEs in the carrier/frequency channel that can also transmit LTE SLSS. Those NR SL UEs may indicate to LTE SL UEs higher priority synchronization source than the source that they are currently using. For example, if an NR SL UE is synchronized to the NR SL UE that is using GNSS as the synchronization reference the NR SL UE can forward its own timing synchronization information using both LTE SLSS and NR SLSS transmissions.

These procedures and operations can be variously implemented. The following discussions are non-limiting examples. Regarding timing synchronization based on LTE SLSS reception, there can be an operating mode where the NR UE is also capable of decoding LTE PSBCH so that the NR UE is aware of LTE SL DEN and subframe numbers. The NR UE may even be aware of resource pools configured or preconfigured for LTE. In this case, the NR UE could know the time instances when no LTE resource pools are configured and could use those times for NR SL transmissions. Another mode is that NR SL UE may only detect subframe boundaries based on LTE SLSS transmissions, and in such case LTE PSBCH decoding may not be done.

Instead of SLSS detection, subframe boundary detection can be based on time and frequency characteristics of LTE SL signal as mentioned above, including PSD characteristics. LTE PSCCH and PSSCH can be transmitted using SC-FDMA so that PSCCH and PSSCH may be separately precoded. This means that in the time domain the transmitted signal can include simultaneously transmitted quaternary phase shift keyed (QPSK) symbols, such as PSCCH, and QPSK/quadrature amplitude modulation (QAM) symbols, such as PSSCH. The determination of starting and ending points of LTE SL subframes may be easier compared to normal orthogonal frequency division multiplexing (OFDM) because amplitude variation of LTE SL signal may be smaller than OFDM signals. The accuracy of timing of subframe boundaries may be improved by analyzing multiple LTE SL transmissions across multiple sub-channels and subframes and then averaging the result.

In some embodiments, the NR UE can compute the spread of the subframe boundaries and can exclude from the averaging any LTE UE transmission for which the associated subframe boundary offset is above a threshold, for example based on maximum propagation delay or a relative difference towards the other LTE UEs. Other ways of detecting outliers is also permitted. In this way, the NR UE can ensure that the NR UE is detecting the subframe boundary representative of the majority of the LTE UEs, rather than becoming biased by a LTE UE with poor synchronization or other idiosyncratic behavior.

The DMRS of LTE PSCCH could also be used to detect timing of the LTE SL or to improve accuracy of the method based on finding the starting and ending points of the LTE SL transmissions. The DMRS sequence of the LTE PSCCH is specified in the standard. Within the standard definition, the only random aspect in the sequence is the cyclic shift value. The transmitting UE can select one out of four possible cyclic shift (CS) values for PSCCH DMRS. The NR UE could correlate the received PSCCH with the four different CS versions and select the location of strongest correlation peak that is also closest to the timing obtained with starting/ending point method. Because the length of the sequence is only 24 elements with 15 kHz spacing, the initial accuracy of the timing may not be good, but correlations with multiple DMRS sequences can be averaged to get more accurate timing information.

Some of the SL-SSIDs transmitted with NR S-PSS/S-SSS could be defined to indicate that the source of the timing is LTE UE. For example, it could be defined that in the channel that is used for both LTE and NR SL transmissions NR SLSS-IDs [1, 167] indicate that the timing source is from LTE UE that is synchronized to eNB and SLSS-IDs [168, 335] indicate that the timing source is NR UE synchronized to eNB/gNB. SLSS-ID for multiple hops can be generated in the way already specified by adding the value 336 to the one hop value. Also, one SLSS-ID value could be reserved for GNSS timing obtained from LTE UE and another value if GNSS of LTE UE is forwarded over multiple hops of LTE UEs.

In the case that synchronization obtained from LTE UEs has the same or higher priority than synchronization obtained from NR UEs, LTE based synchronization should be selected. In the case that synchronization from LTE SL UEs has lower priority then the procedure explained below may be used.

As mentioned above, if priority of LTE synchronization source is lower than the synchronization source of the NR UE, it may be better if NR UEs don't switch to use LTE timing. For example, if NR UEs have GNSS coverage but the nearby LTE SL UEs use their internal clock for synchronization it may be better to assume that also LTE UEs can find GNSS after a while when they have moved to a better position. Meanwhile NR UE may detect LTE synchronization signals and indicate the timing offset between LTE and NR to other NR UEs nearby. NR UEs could then use slots that are fully overlapping with LTE subframes, which may assume NR uses, for example, 0.5 ms or shorter slots for transmissions and LTE subframe is 1 ms. In order not to overload LTE SL UE's receiver, NR UE could send some dummy data in the symbols where LTE UEs are setting their AGC level, if NR UE plans to transmit in the slot overlapping with LTE, using FDM between LTE and NR.

Detection of LTE synchronization priority may involve the NR UE being aware of configuration on priority of LTE synchronization source. The NR UE may acquire such information either from the eNB if the NR UE has capability of LTE downlink (DL) reception or the NR UE can be pre-configured in the same way as an LTE SL UE.

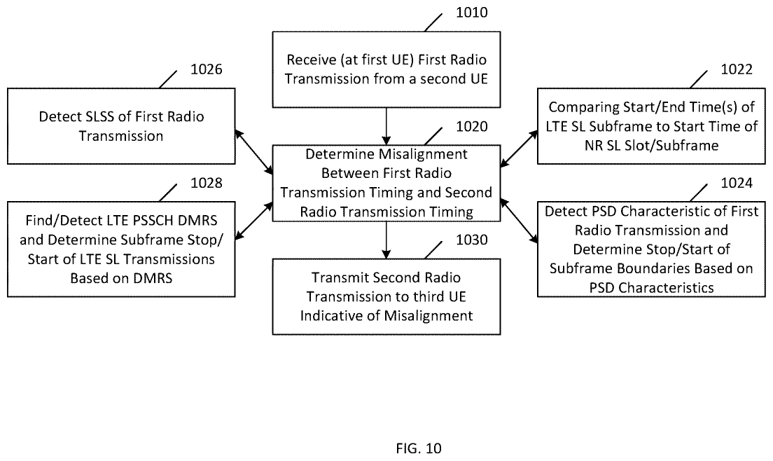

FIG. 10 illustrates an example flow diagram of a method for providing synchronization of user equipment of different radio access technologies, such as long term evolution and new radio sidelink, coexisting in the same channel, according to certain embodiments.

FIG. 10 illustrates a method according to certain embodiments. The method of FIG. 10 may be performed by a first user equipment, which may be a NR SL UE. The method can include, at 1010, receiving at the first user equipment a first radio transmission from a second user equipment. The second user equipment may be different from the first user equipment and may, for example, be an LTE SL UE.

The first radio transmission can be a synchronization signal (SLSS) of the second UE. The first radio transmission can include PSSCH and PSCCH of the second UE.

The method may also include, at 1020, determining, based on the received first radio transmission, a misalignment between a first radio transmission timing of the first UE and a second radio transmission timing of the second UE.

The determining the misalignment at 1020 can include, at 1022, determining a starting time (t0) and/or an ending time (t1) of a first radio access technology (RAT) subframe such as the LTE SL subframe based on the first radio transmission and comparing the determined t0/t1 to a starting time of a second RAT slot/subframe, such as an NR SL slot/subframe. The determining the misalignment at 1020 can also or alternatively include, at 1024, detecting a power spectral density (PSD) characteristic of the first radio transmission and deriving a value of at least one of a starting time or an ending time of a sidelink subframe of a first radio access technology and comparing the value to a starting time of a subframe or slot of a second radio access technology. In this case, the first radio transmission can include LTE PSSCH and LTE PSCCH. The determining the misalignment at 1020 can also or alternatively include, at 1026, detecting SLSS of the first radio transmission.

Thus, there can be three methods of determining misalignment or timing difference between LTE and NR SL, or any other timing used respectively for the first and second radio transmission. A first method, shown at 1026 and discussed above, can involve an NR UE having LTE SLSS reception capability, such that the NR UE can find subframe boundaries in the same way as LTE SL UEs. A second method, shown at 1024 and discussed above, can involve an NR UE detecting that the received signal has PSD characteristics of LTE SL and finding when the received signal starts and stops. A third method, shown at 1028, can involve an NR UE finding/detecting LTE PSCCH demodulation reference signals and based on the DMRS the NR UE determining subframe starting and ending of LTE SL transmissions as described above. These could be alternatives or complementary methods.

At 1030, the method can include transmitting a second radio transmission to a third UE, which may be a NR SL UE or LTE SL UE. The transmission to the third UE can be indicative of the determined misalignment. The first UE, second UE, and third UE can operate in a same SL channel or on a same sidelink carrier.

In certain embodiments, the second radio transmission can be a synchronization signal, such as SLSS, of the first UE. In certain embodiments, the second radio transmission can include a message transmitted from the first UE to the third UE.

The transmitting the second radio transmission at 1030 can be dependent on a priority associated with the received first radio transmission. The second radio transmission can include a time offset indicative of the determined misalignment.

It is noted that FIG. 10 is provided as one example embodiment of a method or process. However, certain embodiments are not limited to this example, and further examples are possible as discussed elsewhere herein.

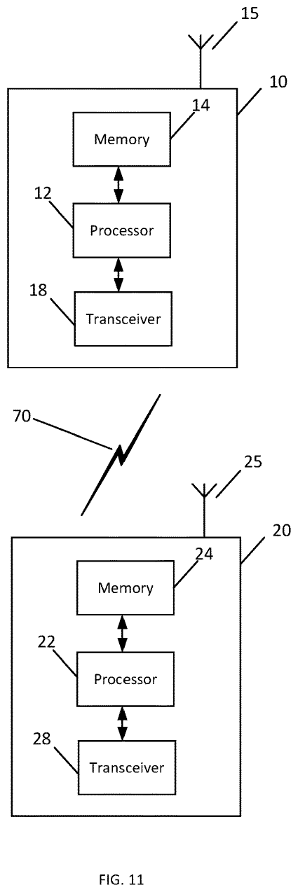

FIG. 11 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 11.

As illustrated in the example of FIG. 11, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 11, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1A to 10, or any other method described herein. In some embodiments, as discussed herein, apparatus 10 may be configured to perform a procedure relating to providing synchronization of user equipment of different radio access technologies, such as long term evolution and new radio sidelink, coexisting in the same channel, for example.

FIG. 11 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 11.

As illustrated in the example of FIG. 11, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1A to 10, or any other method described herein. For example, in an embodiment, apparatus 20 may be controlled to perform a process relating to providing synchronization of user equipment of different radio access technologies, such as long term evolution and new radio sidelink, coexisting in the same channel, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may provide an improvement and enhancement to the way that synchronization can occur between UEs of different RATs, such as LTE UEs and NR SL UEs. Furthermore, certain embodiments may permit a UE to obtain timing information from a radio of another RAT without needing to be able to decode the bits provided by the other radio. Thus, for example, certain embodiments can leverage radio frequency (RF) characteristics, such as PSD in received signals to obtain timing information even in the absence of a common timing source.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

AGC Automatic Gain Control
BSM Basic Safety Message
CA Carrier aggregation
CAM Cooperative Awareness Message
DC Dual Connectivity
DEN Direct Frame Number
DMRS DeModulation Reference Signal
HARQ Hybrid Automatic Repeat Request
MCS Modulation and Coding Scheme
OFDM Orthogonal Frequency Division Multiplex
PRB Physical Resource Block
PSBCH Physical Sidelink Broadcast Channel
PSCCH Physical Sidelink Control Channel
PSD Power Spectral Density
PSFCH Physical Sidelink Feedback Channel
PSSCH Physical Sidelink Shared Channel
QPSK Quadrature Phase Shift Keying
QAM Quadrature Amplitude Modulation
RP Resource Pool
RX Receiver
SCI Sidelink Control Information
SA Scheduling Assignment
SCS Sub Carrier Spacing
SL SideLink
SLSS Sidelink Synchronization Signal
TB Transport Block
TX Transmitter
U2N UE-to-Network Relay
V2X Vehicle-to-Everything

1. An apparatus, comprising:
at least one processor; and
at least one memory including computer program code,
wherein the at least one memory and the computer program code are configured to, with the at least one processor, cause a first user equipment at least to
receive, at the first user equipment, a first radio transmission from a second user equipment;
determine, based on the received first radio transmission, a misalignment between a first radio transmission timing of the first user equipment and a second radio transmission timing of the second user equipment; and
transmit a second radio transmission to a third user equipment indicative of the determined misalignment.

2. The apparatus of claim 1, wherein the first user equipment, the second user equipment, and the third user equipment are configured to operate in a same sidelink channel or on a same sidelink carrier.

3. The apparatus of claim 1, wherein the first radio transmission comprises a synchronization signal of the second user equipment.

4. The apparatus of claim 1, wherein the first radio transmission comprises a physical sidelink shared channel, a physical sidelink control channel, or both the physical sidelink shared channel and the physical sidelink control channel of the second user equipment.

5. The apparatus of claim 1, wherein the determining the misalignment comprises determining a value of at least one of a starting time or an ending time of a sidelink subframe of a first radio access technology based on the first radio transmission and comparing the value to a starting time of a subframe or slot of a second radio access technology.

6. The apparatus of claim 1, wherein the determining the misalignment comprises detecting a power spectral density characteristic of the first radio transmission and deriving a value of at least one of a starting time or an ending time of a sidelink subframe of a first radio access technology and comparing the value to a starting time of a subframe or slot of a second radio access technology.

7. The apparatus of claim 1, wherein the second radio transmission comprises a synchronization signal of the first user equipment.

8. The apparatus of claim 1, wherein the second radio transmission comprises a message transmitted from the first user equipment to the third user equipment.

9. The apparatus of claim 1, wherein the transmitting the second radio transmission is dependent on a priority associated with the first radio transmission.

10. The apparatus of claim 1, wherein the second radio transmission comprises a timing offset indicative of the misalignment.

11. A method, comprising:
receiving, at a first user equipment, a first radio transmission from a second user equipment;
determining, based on the received first radio transmission, a misalignment between a first radio transmission timing of the first user equipment and a second radio transmission timing of the second user equipment; and
transmitting a second radio transmission to a third user equipment indicative of the determined misalignment.

12. The method of claim 11, wherein the first user equipment, the second user equipment, and the third user equipment are operating in a same sidelink channel or on a same sidelink carrier.

13. The method of claim 11, wherein the first radio transmission comprises a synchronization signal of the second user equipment.

14. The method of claim 11, wherein the first radio transmission comprises a physical sidelink shared channel, a physical sidelink control channel, or both the physical sidelink shared channel and the physical sidelink control channel of the second user equipment.

15. The method of claim 11, wherein the determining the misalignment comprises determining a value of at least one of a starting time or an ending time of a sidelink subframe of a first radio access technology based on the first radio transmission and comparing the value to a starting time of a subframe or slot of a second radio access technology.

16. The method of claim 11, wherein the determining the misalignment comprises detecting a power spectral density characteristic of the first radio transmission and deriving a value of at least one of a starting time or an ending time of a sidelink subframe of a first radio access technology and comparing the value to a starting time of a subframe or slot of a second radio access technology.

17. The method of claim 11, wherein the second radio transmission comprises a synchronization signal of the first user equipment.

18. The method of claim 11, wherein the second radio transmission comprises a message transmitted from the first user equipment to the third user equipment.

19. The method of claim 11, wherein the transmitting the second radio transmission is dependent on a priority associated with the first radio transmission.

20. The method of claim 11, wherein the second radio transmission comprises a timing offset indicative of the misalignment.

21.-32. (canceled)
